(19) United States
(12) Patent Application Publication
(10) Pub. No.: US 2004/0074141 A1
(43) Pub. Date: Apr. 22, 2004

(54) Method of protecting urban planted trees from parked bicycles and other vehicles

(75) Inventor: Barbara Eber-Schmid, Livingston, NJ (US)

Correspondence Address: STANLEY H. KREMEN, 4 LENAPE LANE, EAST BRUNSWICK, NJ, 08816, US

(73) Assignee: NYC STREET TREE CONSORTIUM, INC.

(21) Appl. No.: 10/271,714

(22) Filed: Oct. 16, 2002

(51) Int. Cl. A01G 13/02

(52) U.S. Cl. 47/32.4

(57) ABSTRACT

A method of providing a secure, theft-resistant bicycle parking facility in the vicinity of a tree that has been planted in an urban area while also protecting said tree from damage caused by parked bicycles, bicycle chains, or locking devices, comprising surrounding said tree by a plurality of rigid and immobile modular bicycle racks. This invention enhances and protects the environment by protecting urban planted trees. In addition this invention provides increased inexpensive parking for bicycles thereby promoting their use in cities in place of automobiles. The environment is further protected by decreasing air pollution caused by emissions from automobile exhausts.

### CROSS REFERENCE TO RELATED APPLICATION(S)/CLAIM OF PRIORITY

Not applicable.

### STATEMENT REGARDING FEDERALLY SPONSORED RESEARCH OR DEVELOPMENT

Not applicable.

### BACKGROUND

### FIELD OF THE INVENTION

This invention relates to use of modular bicycle racks used for parking bicycles in urban areas in order to prevent bicycle theft. The modular bicycle racks are used in combination with other such modular bicycle racks. The plurality of these bicycle racks combine to surround and protect urban planted trees from damage to their trunks from parked bicycles. They also encourage cyclists to park their bicycles in the vicinity of trees. Since tree planting on city streets is necessary for protection of the environment, this invention insures that the trees, and therefore the environment, will remain safe. Furthermore, with this invention several bicycles can be parked around a single tree. The availability of secure bicycle parking on city streets further promotes the use of bicycles for transportation in place of automobiles. Encouraging the use of bicycles for transportation is also helpful to the environment as it decreases pollution caused by air emissions from automobile exhausts.

### BACKGROUND OF THE INVENTION

In an age of increasing environmental awareness, there is a very real conflict between two positive environmental practices in our city centers—the planting and maintenance of street trees and the increased use of bicycles for commuting, business, and recreational purposes.

Based on an informal survey of both suburban and urban business districts in New York, New Jersey, Florida, and California, TREES NEW YORK has found that street trees are often used for bike storage, even when bike racks are available. Consequently, bicycles are chained to street trees, which often causes physical harm to the trees. The problem is exacerbated by inadequate bicycle parking facilities throughout most urban areas.

Unprotected trees in areas without bike parking are often the only place cyclists have to chain expensive bicycles. The problem is particularly serious for young trees which arc easily damaged by bark stipping and decapitation. Such “abused” street trees have a high mortality rate. Security chains placed lightly around a tree trunk will eventually injure the bark. Bark protects the tree in several ways—it absorbs impact, it protects against severe weather, but most importantly, it protects the phloem cells that transport the carbon and sugar during photosynthesis. These nutrients feed the cambium layers, which in turn, produce the tree's inside wood and outside bark. These cells are also involved in nutrient transport of the roots. The phloem cells. which completely surround the tree, are only as thick as a layer of human skin. If this layer is compressed or cut, it stops the transportation of nutrients to all points further down the tree. A bicycle chain, wrapped around a tree trunk, can kill a tree by damaging a narrow band of phloem cells encircling the trunk, even though this amounts to a very small fraction of the cells in the tree. Often, bike riders abandon locked chains at tree sites. As the tree grows this has the effect of ultimately strangling the tree

For more than a century, wrought iron tree guards have been used to protect tree trunks from damage. These tree guards are permanently mounted around the tree while the tree is still a sapling. In time, as the tree grows, the diameter of a tree trunk becomes larger until the metal grill of the tree guard itself strangles the tree. Cities often plant trees inside soil beds surrounded by brick or cement wells so as to prevent damage to the trees A bike rider cannot park and lock a bicycle at such a location. Sometimes a small wrought iron fence protrudes from the brick or stone structure, and such an extension could facilitate bicycle parking. Some cities place street trees inside large metal fenced in areas. Bicycles can be attached to fences such as these. However, the structures described are often expensive and unsightly. Tree pit guards in New York City are frequently used as bicycle racks, whether or not they were designed for that purpose. These guards vary greatly in the protection they provide for the tree and the bicycle.

The problem is to come up with a method to both protect street trees from parked bicycles and, at the same time, to provide the location of said trees as a welcoming site for bicycle parking. The solution to this problem requires the following constraints:

“First, do no harm.” Any physical structure must allow for tree growth and must be secured to the site in a manner that will not disturb the tree's root system.

Any physical structure must discourage or actually prevent a bicycle from being chained to a tree trunk Instead it should encourage attachment of the bicycle directly to the structure.

Ideally, the structure will provide some protection from a low speed vehicular impact.

The structure must be tall enough to encourage attachment of the bicycle to the structure. It may not be small enough to pose a trip hazard to pedestrians.

The design of any structures used should discourage littering, but should allow easy access for cleaning if litter does accumulate in or near the tree pit. For example, a “boxy” design should be avoided since it is likely to be viewed by pedestrians as a garbage receptacle.

The structure must not raise the level of soil around the tree.

Aesthetically, the design should be appropriate (or modifiable) for a number of distinct urban contexts (residential, commercial, industrial).

The method described herein requires the use of multiple modular bicycle park-and-lock stands to surround a tree for its protection while never coming in contact with the tree or its root system. The prior art shows that bicycle parking racks of varying designs and constructions have been used for many years in cities and towns around the world. A search of the prior ail, both patent and non-patent, and both domestic and foreign, did not reveal any reference or combination of references that teaches the use of modular bicycle racks for providing, at the location of a street tree, secure parking of bicycles, and, at the same time, providing protection for the tree.

### SUMMARY OF THE INVENTION

The method described herein, which is the subject of this invention, utilizes a plurality of modular bicycle racks or bicycle locking stands to surround a tree in such a manner as to prevent a bicycle from having access to the tree. The modular bicycle locking stands are firmly anchored to the ground. They surround the tree sufficiently far away as not to cause damage themselves to any element of the tree such as the tree trunk or roots. This plurality of modular bicycle locking stands present to bicycle owners a much larger perimeter than the circumference of the tree trunk. It also permits a plurality of bicycles to be parked in the vicinity of a single tree.

### THERE ARE NO DRAWINGS CONTAINED IN THIS PATENT APPLICATION

### DETAILED DESCRIPTION OF THE PREFERRED AND ALTERNATE EMBODIMENTS

This invention is a method of using a plurality of modular bicycle racks to surround a tree so as to deny direct access to the tree by a bicycle, a bicycle chain, or a bicycle locking device. Yet the arrangement of bicycle racks serves directly as a station for securely parking bicycles in the vicinity of a tree.

Each module must allow for secure attachment of at least one bicycle. A module must be made of metal, must be rust resistant, and must have an enclosure. such as a circular area, through which a chain or other locking device can be threaded. The modular bicycle rack must be tall enough, and the enclosure through which the locking device can be threaded must be high enough off the ground so that the bike frame (rather than the bike wheel) can be attached. The module must be capable of being firmly attached to the ground (usually a sidewalk) surrounding a tree pit so that the module is immovable. In some places, there is no concrete, brick, cement, or other stone-like sidewalk around the tree. This is the condition that exists in a park. Under these circumstances, an immovable rigid structure would have to be laid on top of the soil surrounding the tree to act as a mounting medium for the bicycle rack. Once attached to the ground, the modular bicycle rack becomes immobile. Therefore, unless the locking device is picked or cut or unless the bicycle is dismantled or broken. a bicycle attached to a parking module is secure from theft.

Additional modular bicycle racks of the type just described are then mounted in sufficient number so as to completely surround the tree. Clearly, the use of a greater number of modules to surround a tree permits more bicycles to be parked in the vicinity of the tree. However, the number of modules cannot be so great so as to provide to cyclists inside the perimeter an area large enough to accommodate one or more bicycles Under these circumstances, even though some bicycles may be parked at the perimeter of the arrangement of bicycle racks, one or more bicycles could be parked in the center at the position of the tree itself On the other hand, the number of modules cannot be so small as to either have contact with the tree or its root system. Also, the number and arrangement of bicycle racks must not provide so small a perimeter as to permit bicycles to attach directly to the tree despite the presence of the bicycle racks.

Therefore, there is a minimum distance away from the tree at which a module may be placed. This is determined by the anticipated growth of the tree. A mature tree can grow to be two feet in diameter or even larger. The tree must have plenty of room to grow. On the other hand, there is a maximum distance away from the tree at which a module may be placed. Modules may not be placed so far away from the tree such that the arrangement of modules permits bicycles to be placed inside the perimeter of the arrangement. In addition, the modules must be placed close enough to each other as to prevent a bicycle from being inserted between the modules in a manner that the bicycle would have direct access to the tree. Ideally, the number and arrangement of the modular bicycle racks should be chosen as to maximize the number of bicycles that can be parked in the vicinity of a tree. However, aesthetics could play a very important role in deciding whether to surround the tree with a square or circular arrangement of modules.

Where a tree is planted at a curbside. it may not be necessary to completely surround the tree with the modular bicycle racks. Bicycles are virtually always parked on a sidewalk and not in the street. Therefore, because it would be less expensive, it is sufficient to surround the tree on all sides of the sidewalk and to leave the curbside free of bicycle racks. However, in this case, the remaining modules should be positioned close enough together so as to prevent damage to the trees on the curb side by acting as a guard against opening car doors.

I claim the following:

1. A method of providing a secure, theft-resistant bicycle parking facility in the vicinity of a tree that has been planted in an urban area while also protecting said tree from damage caused by parked bicycles, bicycle chains, or locking devices, comprising surrounding said tree by a plurality of rigid and immobile modular bicycle racks such that:
said modular bicycle racks each permit at least one bicycle to be securely attached to it and to be parked thereby;
the number and arrangement of said modular bicycle racks is chosen so as to:
provide a perimeter sufficiently large to prevent direct damage to said tree by said bicycle racks, the calculation of said perimeter taking into account the anticipated growth and increase in trunk diameter of said tree;
provide a perimeter sufficiently large to prevent said parked bicycles or said locking devices parked outside said perimeter from having direct contact with said tree;
provide a perimeter sufficiently small to prevent said bicycles from being parked inside said perimeter; and,
be sufficiently close to each other to prevent said bicycles from fitting in-between said modular bicycle racks and therefore having direct contact with said tree.

2. The method of claim 1 wherein said modular bicycle racks are each constructed from metal.

3. The method of claim 2 wherein said modular bicycle racks are each constructed from metal that is rust resistant.

4. The method of claim 1 wherein said modular bicycle racks each have an enclosure through which a chain or other locking device can be threaded.

5. The method of claim 1 wherein said modular bicycle racks are securely mounted to a cement, concrete, brick, or other stone-like sidewalk that surrounds said tree.

6. The method of claim 1 where, in the absence of a cement, concrete, brick, or other stone-like sidewalk that surrounds said tree, and the presence of only dirt upon which said modular bicycle racks may be mounted, a rigid surface is first securely placed on top of said dirt, and said modular bicycle racks are then securely attached to said rigid surface, wherein the combination of said modular bicycle racks and said rigid surface renders the entire structure immobile.

7. The method of claim 1 wherein the number and arrangement of said modular bicycle racks is such that, for a tree planted by a curb, no modular bicycle rack is positioned on the curb side.

8. The method of claim 7 wherein said number and arrangement of said modular bicycle racks is such that car doors being opened on said curb side would not cause damage to said tree.
